(19) United States
(12) Patent Application Publication
(10) Pub. No.: US 2013/0085656 A1
(43) Pub. Date: Apr. 4, 2013

(54) METHOD FOR OPERATING A COMBUSTION ENGINE WHEN CHANGING FROM FULL ENGINE OPERATION TO PARTIAL ENGINE OPERATION

(71) Applicants: Oliver Grunwald, Buxheim (DE); Armin Koehler, Ingolstadt (DE); Thierry Delcour, Muenchen (DE)

(72) Inventors: Oliver Grunwald, Buxheim (DE); Armin Koehler, Ingolstadt (DE); Thierry Delcour, Muenchen (DE)

(73) Assignee: Audi AG, Ingolstadt (DE)

(21) Appl. No.: 13/432,646

(22) Filed: Mar. 28, 2012

(30) Foreign Application Priority Data
Mar. 29, 2011 (DE) 10 2011 015 368.3

(51) Int. Cl. F02D 41/00

(52) U.S. Cl. CPC F02D 41/00
USPC 701/103

(57) ABSTRACT

In a combustion engine, combustion chamber-specific deviations can be equalized by associating a specific adjustable air-fuel ratio with the individual combustion chambers. When changing from full engine operation to partial engine operation, the associated air-fuel ratios do not always remain optimal. A new air-fuel ratio, which is adjusted immediately when changing from full engine operation to partial engine operation, is then associated with the combustion chambers of a subgroup of combustion chambers to which an air-fuel mixture is applied in partial engine operation. The new individual air-fuel ratios can be easily computed, in particular, from the individual air-fuel ratios associated with full engine operation.

### CROSS-REFERENCES TO RELATED APPLICATIONS

This application claims the priority of German Patent Application, Serial No. 10 2011 015 368.3, filed Mar. 29, 2011, pursuant to 35 U.S.C. 119(a)-(d), the content of which is incorporated herein by reference in its entirety as if fully set forth herein.

### BACKGROUND OF THE INVENTION

The present invention relates to a method for operating a combustion engine, and more particularly to operating a combustion engine when changing from full engine operation to partial engine operation.

The following discussion of related art is provided to assist the reader in understanding the advantages of the invention, and is not to be construed as an admission that this related art is prior art to this invention.

Combustion engines typically have a plurality of the combustion chambers. A differentiation is made between several operating modes and/or operating methods, for example two operating methods referred to as full engine operation and partial engine operation. In full engine operation, an air-fuel mixture is applied to all combustion chambers. In the second operating method, the partial engine operation, an air-fuel mixture is applied to only a subgroup of the combustion chambers, whereas combustion takes place only once in the remaining combustion chambers, with the exhaust gas remaining in the combustion chamber. If the subgroup includes exactly half of the combustion chambers, this mode is also referred to as half engine operation.

It is known that the combustion chambers may have structural differences. For example, more fuel may need to be injected into one combustion chamber than into another combustion chamber so as to obtain on average the typically desired air-fuel ratio of exactly one, which allows the entire fuel to be precisely combusted by the oxygen present. Accordingly, an individual air-fuel ratio is determined for each combustion chamber. It is known to execute so-called lean ramps, i.e. to successively increase the air-fuel ratio in a specific combustion chamber until the combustion engine runs rough. Rough running can then be associated with a certain value for the air-fuel ratio, allowing the injection to be calibrated in this manner. After an individual air-fuel ratio has been associated with each combustion chamber, this air-fuel ratio is adjusted in full engine operation, namely through injection of fuel and supply air controlled by a controller, using the associated values for the air-fuel ratio as the starting point.

The previously determined individual air-fuel ratios are typically maintained when changing from full engine operation to partial engine operation. If the overall air-fuel ratio deviates from one when several combustion chambers having an individual air-fuel ratio significantly different from one are eliminated, the engine controller adjusts the overall air-fuel ratio once more to one. However, more or less fuel is collectively supplied to the combustion chambers of the subgroup with this type of control. On the other hand, this does not adequately take into account in the individual deviations in the structure and the operating mode of the combustion chambers, which may cause excessive pollutant emissions in relation to the power of the combustion engine. Disadvantageously, the control reacts quite sluggishly and hence with a delay after changing from full engine operation to partial engine operation.

It would therefore be desirable and advantageous to obviate prior art shortcomings and to improve the efficiency of a combustion engine which is configured for both full engine operation and partial engine operation.

### SUMMARY OF THE INVENTION

According to one aspect of the present invention, a method for operating a combustion engine having a plurality of combustion chambers includes the steps of applying an air-fuel mixture to all combustion chambers for full engine operation, associating an individual air-fuel ratio with each combustion chamber for full engine operation, applying the air-fuel mixture to only a subgroup of the combustion chambers for partial engine operation, and associating a new individual air-fuel ratio with the combustion chambers of the subgroup for partial engine operation, wherein the new individual air-fuel ratio is adjusted immediately when changing from full engine operation to partial engine operation.

According to one advantageous feature of the present invention, the injection of the fuel and the supply of air into the individual combustion chambers may be individually adapted not only in full engine operation but also in partial engine operation. This improves the efficiency of the operation of the combustion engine.

According to one advantageous feature of the present invention, instead of executing a separate lean ramp for partial engine operation, the new individual air-fuel ratio may be computed at least for the combustion chambers of the subgroup based on the previous air-fuel ratios defined for or associated with full engine operation. This is based on the observation that the measurements of the combustion chamber-specific deviations are already reflected in the individual air-fuel ratios of the combustion chambers of the subgroup, thus obviating the need for new measurements.

According to another advantageous feature of the present invention, the individual air-fuel ratios for full engine operation may be determined with the method by specifically applying lean exhaust gas with a changing air-fuel ratio (in particular with continuously increasing air-fuel ratio) to the individual combustion chambers. The aforementioned method is hereby purposely not performed for partial engine operation. Executing a lean ramp necessitates certain operating and driving conditions which must be identified by the engine controller. Such conditions do typically not exist when changing from full engine operation to partial engine operation; the measurement using the aforementioned method can therefore be performed at an advantageous time during full engine operation. As mentioned above, this measurement is then used as a basis for computing the individual air-fuel ratios for the combustion chambers during partial engine operation.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 a schematic diagram of a combustion engine with four cylinders for describing the operating modes of full engine operation and half engine operation;

FIG. 2 an exemplary diagram describing the individual air-fuel ratios for the individual cylinders of the internal combustion engine of FIG. 1 according to the present invention; and

FIG. 3 a corresponding exemplary diagram for half engine operation according to the present invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

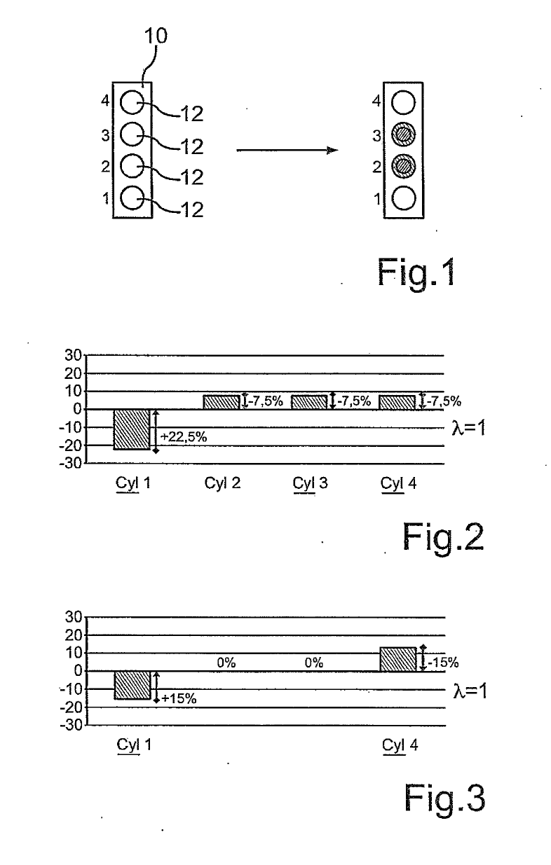

Turning now to the drawing, and in particular to FIG. 1, there is shown a combustion engine indicated by the overall reference symbol 10 with four cylinders 12 which are consecutively numbered from “1” to “4”. An air-fuel ratio is applied to all four cylinders in full engine operation, allowing combustion in these cylinders. In half engine operation, fuel is applied repeatedly only to the cylinders 1 and 4, but only once to the cylinders 2 and 3, with repeated combustion enabled only in the cylinders 1 and 4. It will now be assumed that under suitable measurement conditions a measurement can be performed to determine existing cylinder-specific deviations. For example, the method disclosed in the published US patent applications 2009/0037083 A1 or 2009/0093948 A1, which are both incorporated herein by reference in their entirety, may be performed. A so-called lean ramp is then executed, i.e. increasingly lean exhaust gas is supplied to the cylinder 1, 2 until rough running of the engine is observed. A certain value for lambda can be associated with the rough running.

In the present situation, it will be assumed that the cylinders have been determined to operate normally, but that the cylinder 1 is “too rich” by 30%. This indicates that more fuel and less air need to be applied to cylinder 1, so that the same behavior is achieved as with the other cylinders. The value of 30% hereby corresponds to a lambda value of 0.7.

If a corresponding quantity of fuel would be injected into the cylinder 1, resulting in a value of lambda equal 0.7, whereas the value of number is equal to one in the other cylinders, then desired air-fuel ratio of lambda equal to one would not be attained.

Instead, the values according to FIG. 2 are selected for full engine operation: the cylinder 1 is adjusted to a lambda value of 1.225, the other cylinders to a lambda value of 0.925. The cylinder 1 has then an air fuel ratio which is higher by 30% than the air fuel ratio of cylinders 2, 3 and 4, so that the cylinder-specific deviation is now taken into account. However, the average value of lambda is equal to one, because three times the value of 0.075, meaning 7.5%, is exactly equal to the value of 1-0.775, meaning 22.5%.

The air-fuel ratios required in partial engine operation can now be calculated from these cylinder-specific air-fuel ratios according to FIG. 2: if the values from FIG. 2 were retained, the value for lambda would not be equal to one on average, because the contributions from cylinders 2 and 3 would be missing. The lambda control would then have to provide equalization which, however, would be relatively slow.

In the present situation, the numerical values for the cylinder-specific air-fuel ratios are already calculated ahead of time. When cylinder 1 deviates by 22.5%, an air-fuel ratio of lambda equal to 1.15 must be supplied to cylinder 1 so as to achieve on average the air-fuel ratio of lambda equal one. Cylinder 1 therefore receives approximately 15% more, the cylinder 4 15% less than the normal value. The values of FIG. 3 can be determined directly from the values of FIG. 2, obviating the need for executing a new lean ramp. The new values of FIG. 3 can therefore be adjusted immediately, meaning instantaneously and in particular without a settling time or delay time when changing from full engine operation to partial engine operation. This minimizes emission of noxious pollutants.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method for operating a combustion engine having a plurality of combustion chambers, comprising the steps of:
applying an air-fuel mixture to all combustion chambers for full engine operation,
associating an individual air-fuel ratio with each combustion chamber for full engine operation,
applying the air-fuel mixture to only a subgroup of the combustion chambers for partial engine operation, and
associating a new individual air-fuel ratio with the combustion chambers of the subgroup for partial engine operation, wherein the new individual air-fuel ratio is adjusted immediately when changing from full engine operation to partial engine operation.

2. The method of claim 1, wherein the new individual air-fuel ratio is computed based on the individual air-fuel ratios for full engine operation associated with at least the combustion chambers of the subgroup.

3. The method of claim 1, wherein the individual air-fuel ratios for full engine operation are determined by applying lean exhaust gas with a changing air-fuel ratio to the individual combustion chambers.
